(19) United States
(12) Patent Application Publication
(10) Pub. No.: US 2010/0262049 A1
(43) Pub. Date: Oct. 14, 2010

(54) Pelvic Trainer

(76) Inventors: Pavel Novak, Stetten (CH); Manfred Schulz, Taegerwilen (CH)

Correspondence Address: ST. ONGE STEWARD JOHNSTON & REENS, LLC, 986 BEDFORD STREET, STAMFORD, CT, 06905-5619, US

(21) Appl. No.: 12/823,881

(22) Filed: Jun. 25, 2010

Related U.S. Application Data
(62) Division of application No. 11/758,927, filed on Jun. 6, 2007.
Application No. 11/758,927 is a continuation of application No. PCT/EP2005/013015, filed on Dec. 5, 2005.

(30) Foreign Application Priority Data
Dec. 6, 2004 (DE) 20 2004 019 194.6

(51) Int. Cl. A61H 1/00

(52) U.S. Cl. 601/46

(57) ABSTRACT

A device is used for stimulating the pelvic muscles of a patient. The device comprises a tubular body which is of such a size that it can be placed along the crotch of a human body.

### CROSS-REFERENCE TO RELATED APPLICATIONS

This is a divisional application of pending U.S. patent application Ser. No. 11/758,927 filed on Jun. 6, 2007, which itself is a continuation of International Patent application PCT/EP2005/013015 filed on Dec. 5, 2005, which designates US and which claims priority of German utility model application No. 20 2004 019 194.6 filed on Dec. 6, 2004.

### FIELD OF THE INVENTION

The invention relates to a device for stimulating pelvic muscles.

### BACKGROUND OF THE INVENTION

Urinary incontinence is a widespread condition that occurs very frequently, especially in women. Regardless of how the incontinence is caused (physical, emotional, stress-related, pressure-related, etc.), it is possible for urinary incontinence, and also anal incontinence, to be alleviated or completely eliminated by training of the pelvic muscles (pelvic diaphragm and urogenital diaphragm). This training, i.e. conscious and repeated tensioning of the pelvic muscles, can in principle be done independently by everyone, for example by what is called autogenous training. The effectiveness of this training, however, can be significantly increased by additional measures.

It is known that muscles can be efficiently trained by vibrations. This can be done either passively (with the muscles relaxed) or also actively (during a muscle contraction), generally at frequencies of 20 to 50 Hz. It can also be done by reflex, with involvement of the proprioceptive receptors, at frequencies of 0 to 20 Hz.

Devices are known, specifically in the form of vibration plates, which can be used for training almost all muscles of the body when suitable postures are adopted. These include, for example, devices sold under the name Powerplate by the company called Power Plate (Switzerland). In these devices, vertical oscillations parallel to the plate surface are generated in the range of 30 to 50 Hz. Similar devices are known under the name Fitvibe from the company called GymnaUniphy (Switzerland), in which parallel vertical oscillations are generated in the range of 20 to 60 Hz. Devices are also known (Novotec Medical GmbH) in which antiparallel vertical oscillations or even swaying movements are generated. The aim is to train the pelvic muscles by sitting on a vibration plate.

From U.S. Pat. No. 6,436,029 B1 an external vibratory exercising device for pelvic muscles is known, having a saddle member adapted to be positioned upon the pelvis and the inner thighs of the user.

The above mentioned devices are disadvantageous to the extent that many other muscles and the skeleton itself are caused to oscillate.

For women, there are intravaginal electrostimulators. Intravaginal stimulators are known from WO 01/37732 A1, DE 100 17 915 A1, US 2003/0073881 A1 and GB 2 376 890 A.

Devices for sexually stimulating are known from US 2004/0171910 A1 and US 2004/01 53 013 A1.

From the physiological point of view, these are disadvantageous in that they have to be inserted into the vagina.

It is an object of the present invention to make available a device that responds or stimulates exclusively to the pelvic muscles in question.

It is further object of the invention to design a device which can be used with dressing, in particular with pants, for allowing a training in all environments.

### SUMMARY OF THE INVENTION

According to the invention, these objects are achieved by a device for stimulating the pelvic muscles, having a tubular body which is of such a size that it can be placed along a crotch of a human body.

The tubular body can be placed in the crotch area between the legs, directly at the locations that are to be stimulated, namely the urogenital region and/or the anal region.

By means of this, the pelvic muscles can be stimulated quite specifically in this region, without additional stimulation of other areas that are not needed for eliminating the incontinence.

To put it another way, when the patient has taken up a position on the tubular body, he or she can concentrate exclusively on stimulating the pelvic muscles that are to be trained. The stimulation can now be carried out actively by the patient himself or herself, by performing the movements necessary for the stimulation on the tubular body.

However, it is much more convenient, and also much simpler for the patient, if the device assists in the stimulation.

For this purpose, in another embodiment of the device, the body is provided with a vibration drive.

The vibration drive sets the tubular body in oscillating movements, which ensure the stimulation of the pelvic muscles in question. The patient simply has to take up a position on the tubular body and arrange the latter between the buttocks, and the stimulation is then effected by way of the vibration drive.

In another embodiment, a sensor is provided, by means of which forces exerted on the tubular body by the pelvis can be detected.

This measure has the considerable advantage of allowing an individual adaptation to the particular patient, for example depending on whether the patient is light or heavy and depending on the exact position of the patient on the tubular body. The sensor can also pick up the pressure forces exerted by the pelvic muscles. In this way, it is possible to monitor the stimulation as such, or also the result of the stimulation, that is to say monitor the course of the treatment.

The detected values can additionally be used to control the vibration drive. This opens up the possibility of actively controlling the stimulation, in order to optimize the result of the stimulation.

In another embodiment of the invention, the tubular body is designed as an elastic body.

This measure has the advantage of permitting a certain degree of adaptation to the individual anatomy, thereby providing for particularly close contact between the tubular body and the human body in the region that is to be stimulated. Moreover, this possibility of adaptation gives the patient a more pleasant feeling upon contact with the tubular body.

In another embodiment of the invention, the tube is made of elastic material and is filled with a fluid.

This measure affords a particularly expedient body that provides excellent stimulation results, because the vibrations can be transmitted to the human body radially with respect to the longitudinal axis.

In another embodiment of the invention, the body is rigid.

This measure has the advantage that, in special cases where there is less adaptation, particularly in the case of heavy patients, very specific points of vibration conduction can be created, that is to say the body of the patient adapts to the rigid body, not the other way round.

In another embodiment of the invention, the body is received in a seat.

This measure has the advantage that the stimulation treatment can be carried out in a manner that is particularly convenient for the patient, since he or she simply takes up a position on a seat in which the body is received. This also opens up the possibility of the stimulation being carried out during the patient's daily routine, such that it is possible at the same time to carry out other activities that can be done while sitting, for example reading a newspaper or doing needlework or the like. Thus, direct contact with the body is not needed, and instead the stimulation can also be effected through light clothing.

In another embodiment of the invention, the body can be adjusted relative to the seat.

This measure has the advantage that the body can be moved relative to the seat to a position that is optimal for the patient and also comfortable.

In one embodiment, the seat can be adjusted in height for this purpose. In another embodiment, the seat can also be tilted alternatively or in addition to this.

These embodiments afford a possibility of particularly individual adaptation to the respective anatomy of the patient.

In another embodiment of the invention, the tubular body is rectilinear

This measure has the advantage that such a body is easy to produce and can be integrated in a flat seat surface.

In another embodiment of the invention, the body is curved.

This measure has the advantage that the body as such already corresponds more or less to the curvature found in a patient's urogenital and anal region.

In another embodiment of the invention, the vibration drive is designed in such a way that it causes the tubular body to oscillate in the urogenital section and/or in the anal section.

This embodiment makes it possible either to stimulate only the urogenital region (that is to say anteriorly, the deep transverse perineal muscle and the superficial transverse perineal muscle) or to stimulate only the anal region (posteriorly, the levator ani muscle and the coccygeus muscle). It is also possible to stimulate both regions simultaneously. The device can therefore be used in a versatile way, for example in patients who have problems only in the urogenital region, in patients who have problems only in the anal region, and in patients who have problems in both regions. It is also therefore possible to perform treatment in stages, for example to initially stimulate both regions in order to stimulate all of the pelvic muscles, that is to say in the anal and urogenital regions, and then gradually, if the main concern is urinary incontinence, to stimulate only the urogenital region.

In another embodiment of the invention, the vibration drive is designed in such a way that the tubular body can be caused to oscillate axially, laterally and/or radially

This measure has the advantage that this variation in the direction of oscillation can provide an optimal stimulation result, and it can also be adapted to the anatomical circumstances of different patients. Moreover, by means of the different directions of propagation of the vibrations, it is also possible to make individual adjustments depending on which stimulation direction is more effective and/or more convenient for the patient.

In another embodiment of the invention, the vibration drive is designed in such a way that amplitudes in the range of 0 to 3 mm are generated.

These amplitude ranges have proven particularly effective for promoting stimulation. The amplitude 0 signifies that, in some directions and also in some patients, no oscillation is desired, such that a device equipped with a vibration drive can also be operated without vibration, either permanently or temporarily, with the result that, depending on the type of treatment, stimulation is for a period of time performed exclusively by contraction movements on the part of the patient.

In another embodiment of the invention, the vibration drive generates frequencies in the range of 0 to 100 Hz, in particular in the range of 5 to 30 Hz. Higher frequencies have the effect of relieving pain, for example in cases of contusion of the coccygeal bone.

These frequency ranges have proven particularly effective for stimulation of the pelvic muscles.

In another embodiment of the invention, the sensor has a pressure sensor that detects forces exerted on the body by muscle contraction.

This measure has the advantage that the pressure sensor can detect not only the pressure forces exerted by the body weight, but can also detect the forces exerted by the muscle contraction of the pelvic muscles. This makes it possible to record the success of the stimulation or to perform active control depending on the intensity and incidence of the muscle contraction.

In another embodiment of the invention, the values detected by the sensor or by the sensors are fed to a processing unit.

This measure has the advantage that the values can be processed in the processing unit and can be used for further purposes, for example for documentation purposes, control purposes or other purposes.

In another embodiment of the invention, the values from the processing unit are converted to a view of the muscle contraction on a display.

This measure has the advantage that the patient or an attending physician can visually record and monitor the intensity and success of the stimulation of the muscle contraction. The viewing facility allows the patient to stimulate and train specific muscles.

Predefined contraction patterns with corresponding relaxation phases can advantageously be followed.

It is possible for contraction/relaxation speeds to be detected, displayed, evaluated and/or predefined as an objective.

In another embodiment of the invention, the vibration acceleration is controlled via an acceleration sensor.

This measure has the advantage that the control of the vibration acceleration can be detected actively via the acceleration sensor and regulated. It is also possible, by recording and viewing an EMG (electromyogram), to allow the subject or patient to stimulate and train specific muscles.

The sensors are in this case designed in such a way that the values can also be detected through a patient's clothing.

The length, diameter and shape of the tubular body can vary, with favorable diameter values in the range of approximately 40 to 60 mm, and lengths of approximately 100 to 300 mm. This is also dependent on the desired scope of action, that is to say whether the aim is to achieve stimulation only in the anal region, only in the urogenital region, or in both regions.

Numerous embodiments are possible for the vibration drive. These include:
an electromotively driven unbalance directly on the cylinder or indirectly via a hydraulic system;
an electromagnetically driven unbalance (oscillating magnet) directly in the tubular body or indirectly via a hydraulic system;
a piston driven electromotively via a spindle, with a hydraulic force transmission;
electromagnetically by means of a lifting magnet or plunger coil system, hydraulic force transmission;
electromagnetically by means of one or two solenoid valves (or proportional valves) and in conjunction with a pressure and underpressure reservoir (if appropriate dynamically with one or two pumps), hydraulic force transmission;
pneumatic drive with or without projectile, which impacts a baffle plate (ballistic pressure wave) and thereby creates an expansion of the vibration cylinder;
pneumatically driven pistons.

The sensors can be arranged at suitable locations, regardless of which phenomena are to be detected by them.

If the pressure exerted by the patient is to be detected by a pressure sensor, the latter can detect the deformations of the body as such if the body is elastic. In the case of a rigid body, the latter can be provided with a pressure-sensitive coating or with a pressure-sensitive cover or can be encased in a liquid-filled or gel-filled cylindrical jacket.

It will be appreciated that the aforementioned features and those still to be explained below can be used not only in the cited combination, but also in other combinations or singly, without departing from the scope of the present invention.

### BRIEF DESCRIPTION OF THE DRAWINGS

The invention is described and explained in more detail below on the basis of two selected illustrative embodiments and with reference to the attached drawings, in which:

FIG. 1 shows a longitudinal section through the pelvic region of the body of a human female who has taken up a position on a device according to the invention, specifically in such a way that the crotch is resting on the device in the anal and urogenital region, and

FIG. 2 shows a longitudinal section, comparable to FIG. 1, of a further embodiment of a device according to the invention, with a rigid and curved tubular body that can be moved individually in oscillation.

### DETAILED DESCRIPTION OF THE INVENTION

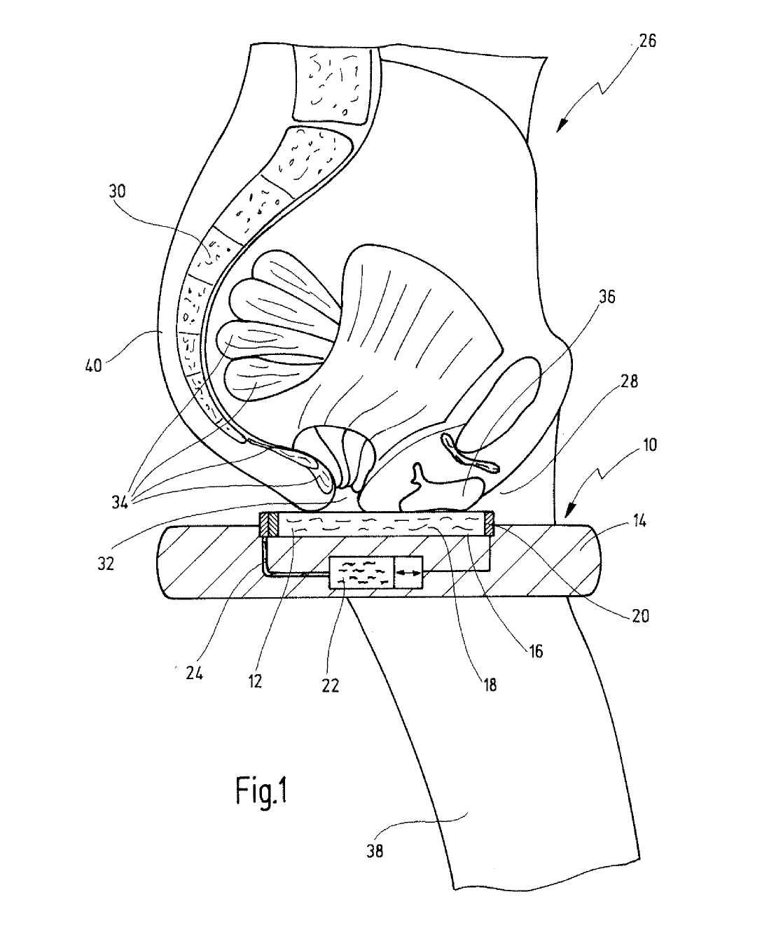

A device 10 shown in FIG. 1 comprises a tubular body 12 composed of an elastic cylinder, e.g. a silicone tube 16, which is filled with a liquid 18, e.g. a silicone oil.

A pressure sensor 20 for detecting muscle contraction is incorporated on one end face. An attachment on the other end face leads via a tube 24 to a central control unit 22 in which a vibration drive is integrated. Force is therefore transmitted hydraulically. The vibrations are generated with a lifting magnet. Such a drive makes it possible, on the one hand, to generate frequencies in the range of 1 to 50 Hz and, on the other hand, to achieve stepless control of the amplitude (and thus also of the acceleration).

FIG. 1 shows how a human female has taken up a position such that the anus 32 and the urogenital region in the area of the vagina 36 rests on the tubular body 12. The buttocks 40 and the spinal column 30 arranged therein rest on the seat surface 14, while the thighs 38 extend laterally from the latter. The device 10 is therefore situated along the individual's crotch 28.

The appropriate muscles 34 can now be activated by the pelvic trainer, for example the levator ani muscle in the anal region, or the corresponding muscles in the urogenital region.

It is thus possible to stimulate these muscle areas in a specific and targeted manner.

The patient is able to stimulate the muscles herself through controlled muscle movements, which is detected by the sensor 20 and can be presented on a suitable display (not shown here).

Stimulation is additionally effected via the vibration drive 24.

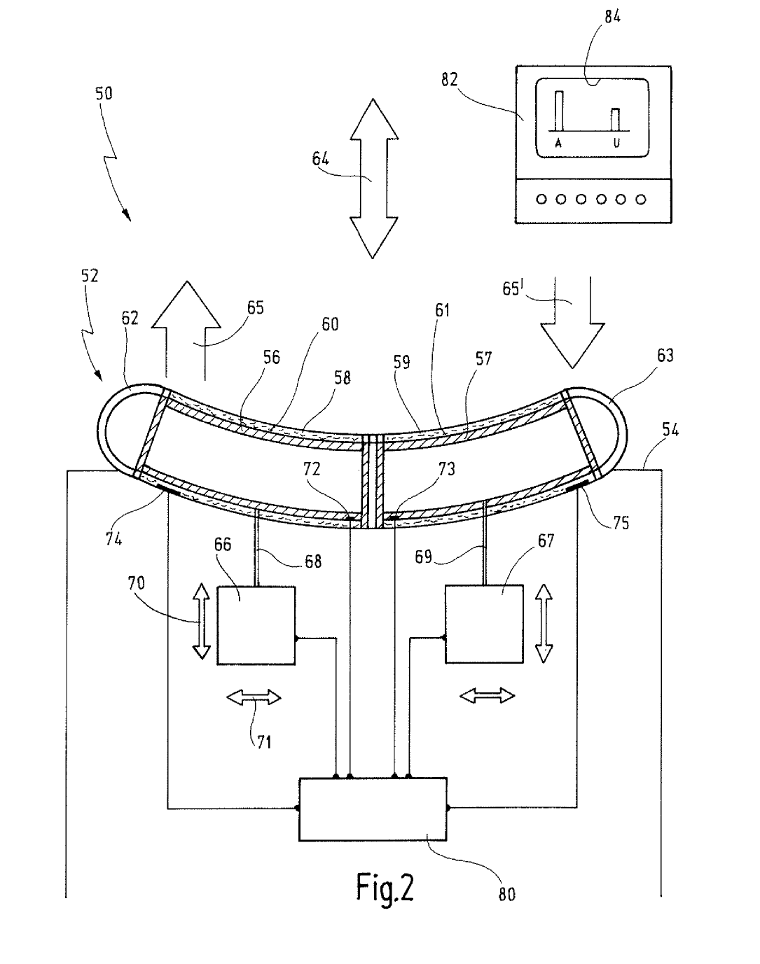

Another embodiment of a device 50 according to the invention is shown in FIG. 2.

The device 50 comprises an approximately tubular body 52 that is received in a seat 54. The body 52 is curved approximately in the shape of an arc of a circle and is therefore better adapted to the urogenital and anal regions of a patient.

The body 52 is composed of two separate hollow cylinders 56 and 57 which lie against one another and are each closed at their ends. The cylinders 56, 57 are made from a metal and have a diameter of approximately 60 mm and a length of in each case approximately 150 mm. Both cylinders 56 and 57 are surrounded by a jacket 58, 59, respectively, which is filled in each case with a gel 60, 61, respectively. At the ends, the body 52 is closed off by rounded caps 62 and 63.

The body 52 itself is received in the seat 54 in a vertically displaceable manner, as is indicated by the double arrow 64. In addition, the body 52 is also arranged to be tiltable in the seat 54, as is indicated by the arrows 65, 65′.

If the body 52 is to be lowered slightly in the urogenital region for example, it can be moved in the direction of the arrow 65′, and, if it is to be lifted in the anal region, this can be done for example in the direction of the arrow 65. Depending on the design of the device, these movements can be carried out jointly or independently of one another.

Both cylinders 56 and 57 are connected to their own drives 66 and 67, respectively, via linking rods 68 and 69. The drives 66 and 67 are designed as vibration drives and can move the two cylinders 56 and 57 of the body in vibratory oscillations independently of one another or simultaneously. These directions can be vertical, as is indicated by the double arrow 70, horizontal, as is indicated by the double arrow 71, or also lateral, i.e. toward and away from the observer looking at FIG. 2. This will depend on the nature of the stimulation treatment

Sensors 72 and 73 are mounted on the cylinders 56 and 57, respectively, and are connected to a processing unit 80 via lines (not shown in detail here). These sensors are designed as acceleration sensors and serve to determine the vibration acceleration and the degree of vibration.

Additional pressure sensors 74 and 75 are arranged in the jackets 58, 59 and are likewise connected to the processing unit 80 via lines (not shown in detail here). The pressure sensors can detect the pressure exerted by a patient who has taken up a position on the device, and in addition they are able to take up the force that is exerted on the body 52 by the stimulated pelvic muscles.

The processing unit 80 is provided with a monitor 82 having a display 84 on which the corresponding measured values can be viewed.

Suitable operating keys can be provided on the monitor 82 for the purpose of individually controlling the two drives 66 and 67 via the processing unit 80.

If, for example, only the urogenital region is to be stimulated, it is possible for only the vibration drive 67 to be actuated.

This control can additionally be used to set the amplitude of the vibration, in most cases between 0 and 3 mm, and the frequency, in most cases in the range between 0 and 100 Hz, in particular in the range between 5 and 30 Hz. The view can, for example, involve bar graphs that show the strength of the contraction forces exerted by the pelvic muscles.

In the illustrative embodiment shown, the letter “A” stands for contraction forces in the anal region, and the letter “U” stands for contraction forces in the urogenital region. It is of course also possible for operating parameters to be viewed and adjusted, for example which drive is in operation and with which amplitude and which frequency. In addition, other parameters can also be displayed, for example the position of the tubular body 12, namely raised or tilted.

In the same way as with a home trainer, a specific contraction/relaxation profile can be predefined or set, which is then “tracked” (biofeedback).

What is claimed is:

1. A device for stimulating pelvic muscles, said device comprising:
a tubular body having a proximal end and a distal end;
said tubular body having a size such that said tubular body can be placed along a crotch of a human body;
said tubular body comprising an outer elastic material filled with a liquid;
said tubular body comprising a vibration drive;
wherein said vibration drive expands and contracts said tubular body in a radial direction.

2. The device of claim 1, wherein said proximal end and said distal end are hemispherical.

3. The device of claim 2, wherein said tubular body radially expands and contracts in three dimensions.

4. The device of claim 1, further comprising at least one sensor wherein said sensor detects forces exerted on said tubular body by a pelvis of a human body.

5. The device of claim 1, wherein said tubular body is received in a seat.

6. The device of claim 5, wherein said body can be adjusted relative to said seat.

7. The device of claim 6, wherein that adjustment is selected from at least adjusting a height and a tilting relative to said seat.

8. The device of claim 1, wherein said body is rectilinear along an axis between said proximal end and said distal end.

9. The device of claim 1, wherein said body is curved along an axis between said proximal end and said distal end.

10. The device of claim 1, wherein said vibration drive generates amplitudes in a range of 0 to 3 mm.

11. The device of claim 1, wherein said vibration drive generates frequencies in a range of 0 to 100 Hz.

12. The device of claim 1, wherein said vibration drive generates frequencies in a range of 5 to 30 Hz.

13. The device of claim 4, wherein said sensor detects forces exerted on said tubular body by a muscle contraction.

14. The device of claim 4, further comprising a processing unit for receiving and processing values of said forces detected by said sensor.

15. The device of claim 14, further comprising a display unit for displaying values of said forces detected by said sensor.

16. The device of claim 15, wherein said display unit displays muscle contractions.

17. The device of claim 1, wherein an acceleration of a vibration provided by said vibration drive is controlled via at least one acceleration sensor.

18. A method for stimulating pelvic muscles, said method comprising the steps of:
providing a tubular body having a proximal end and a distal end, and further having an outer elastic material filled with a liquid;
providing a vibration drive in said tubular body;
placing the tubular body along a crotch of a human body;
expanding and contracting said tubular body in a radial direction.

19. The method of claim 18, wherein the expanding and contracting of said tubular body is in three dimensions.

20. The method of claim 19, wherein the tubular body is placed along the crotch of said human body outside of any clothing.
